(19) United States
(12) Patent Application Publication
(10) Pub. No.: US 2004/0025857 A1
(43) Pub. Date: Feb. 12, 2004

(54) Method and device for regulating the fuel/air ratio of an internal combustion engine

(76) Inventors: Eberhard Schnaibel, Hemmingen (DE); Wolfgang Wagner, Korntal-Muenchingen (DE); Jens Kurt, Denham Uxbridge Middlesex (DE)

Correspondence Address: KENYON & KENYON, ONE BROADWAY, NEW YORK, NY, 10004, US

(21) Appl. No.: 10/400,781

(22) Filed: Mar. 26, 2003

(30) Foreign Application Priority Data
Mar. 27, 2002 (DE) 10213657.2

(51) Int. Cl. F02D 41/14; F01N 3/10

(52) U.S. Cl. 123/692; 60/276

(57) ABSTRACT

A method and a device for regulating the fuel/air ratio of an internal combustion engine having a first cylinder group, whose exhaust gases are guided through a first exhaust duct area, and having a second cylinder group, whose exhaust gases are guided through a second exhaust duct area. The first exhaust duct area contains a first catalytic portion and the second exhaust duct area contains a second catalytic portion. An exhaust gas analyzer probe, arranged upstream from the first catalytic portion, influences the fuel/air ratio of both the first and the second cylinder groups. A second exhaust gas analyzer probe, arranged downstream from the first catalytic portion, influences the fuel/air ratio of the first cylinder group, and a third exhaust gas analyzer probe, arranged downstream from the second catalytic portion, influences the fuel/air ratio of the second cylinder group. An additional exhaust gas analyzer probe upstream from the second catalytic portion may be eliminated.

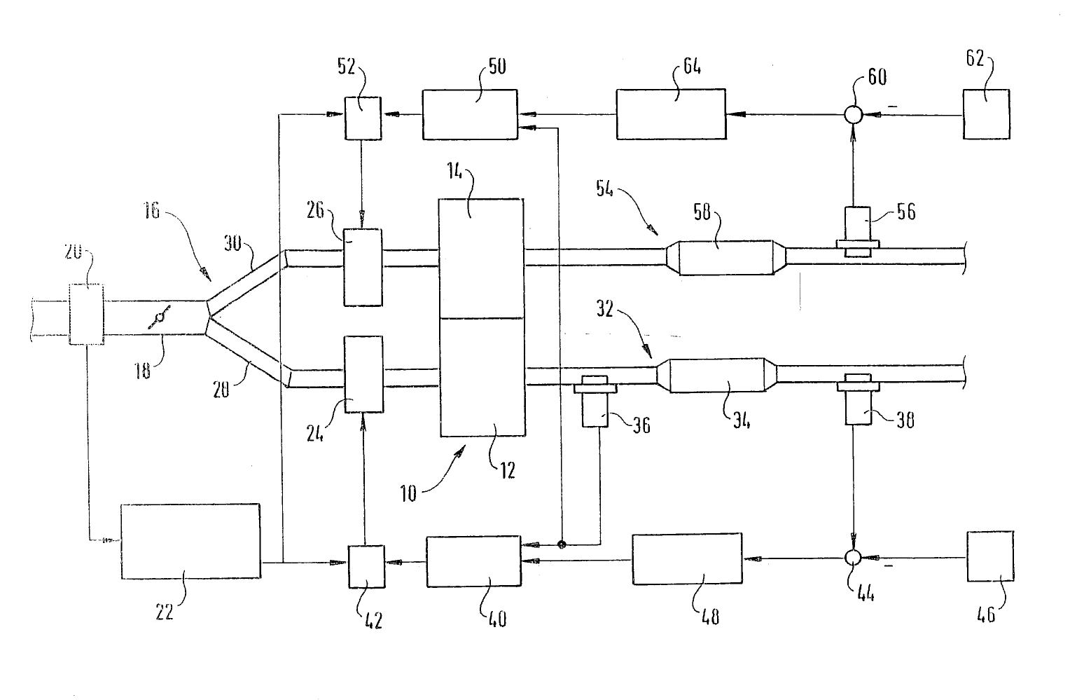

### FIELD OF THE INVENTION

The present invention relates to a method of regulating the fuel/air ratio of an internal combustion engine. The present invention also relates to an electronic control unit implementing an exemplary method and an exemplary device having such an electronic unit including a first and a second exhaust gas analyzer probe.

### BACKGROUND INFORMATION

A method, an electronic control unit, and a device are referred to in German Published Patent Application No. 38 34 711, which involves separately regulating two cylinder banks (cylinder groups) of an internal combustion engine. Exhaust systems having several cylinder group-specific catalytic converters may be used in engines having larger cylinder numbers, e.g., in six- and eight-cylinder engines. Each of these banks may have a separate exhaust duct area, each having a catalytic converter, through which only the exhaust gas of the respective cylinder flows. For measuring the oxygen concentration, an exhaust gas analyzer probe arranged upstream from the respective catalytic converter may be provided for each cylinder bank. This oxygen concentration, measured for each cylinder bank, may then serve as an input variable of a cylinder bank-specific regulating circuit for the fuel/air ratio.

If a fault is detected in one of the two regulating circuits, then the manipulated variable from the intact regulating circuit maybe used as a substitute variable for the presumably faulty manipulated variable in the faulty regulating circuit. However, for normal operation the prior method may still require a cylinder bank-specific exhaust gas analyzer probe arranged upstream from each of the cylinder bank-specific catalytic converters. Other prior engine controllers not only may have exhaust gas analyzer probes arranged upstream from the catalytic converter, but also downstream from the catalytic converter. The catalytic converter facilitates the adjustment of the thermodynamic equilibrium of the different exhaust gas components.

Inaccuracies in the signal of the front probe, being caused by an imperfect adjustment of the thermodynamic equilibrium, are not present, or are at least reduced, in the rear probe. In addition, the catalytic converter may have a balancing effect on the exhaust gas temperature, so that the rear probe may be subjected to less intense exhaust gas temperature fluctuations compared to the front probe. Temperature dependency of the probe signals may thus result in comparably smaller probe signal fluctuations at the rear probe than at the front probe.

However, due to the greater distance from the exhaust valves of the engine, the rear probe may react to changes in the oxygen content in the exhaust gas with more inertia than the front probe. This effect may be reinforced by the feature that the catalytic converter stores oxygen during phases of oxygen surplus, and returns it to the exhaust gas during phases of oxygen shortage, so that the catalytic converter influences the shape of the oxygen concentration over time curve in the exhaust gas, similarly to a low pass filter influencing an alternating electric signal. Against this background, the signal of the rear probe may be less suited as an input variable for a quick-response regulating circuit than the signal of a front probe.

Therefore, other control methods may provide for an internal regulating circuit, which (in its simplified form) may include the internal combustion engine as a controlled system, the front exhaust gas analyzer probe as a control sensor, the one electronic control unit as a regulator, and a fuel metering device as the actuator. The effect of this internal regulating circuit may to some extent be checked by a rear exhaust gas analyzer probe which may correctively intervene in the internal regulating circuit via an external regulating circuit when the oxygen concentration, measured downstream from the catalytic converter, deviates from a setpoint value, so that drift phenomena in the signal of the front probe may be corrected.

In addition, the front probe and the catalytic converter may be diagnosed using the rear probe. Compared to the initially described cylinder bank-specific regulation using separately positioned exhaust gas areas and separate catalytic converters, this may require a front exhaust gas analyzer probe and a rear probe for each of the catalytic converters. In the case of two cylinder banks, this requirement may result in a minimum of four exhaust gas analyzer probes. Exhaust gas analyzer probes may be relatively expensive. In addition, in particular the front probes may require an installation space which may be limited. This may be true in turbo engines in which the turbo-charger may require an installation location which is also suitable for exhaust gas analyzer probes.

### SUMMARY OF THE INVENTION

An exemplary embodiment and/or exemplary method of the present invention may reduce the number of exhaust gas analyzer probes required for an internal combustion engine having separately regulated cylinder groups.

According to an exemplary embodiment and/or exemplary method of the present invention, one variable from the first regulating circuit may be the signal of the first exhaust gas analyzer probe, in that the fuel/air ratio of the second cylinder group is set on the basis of this signal via a second regulating circuit, and the second regulating circuit may be supplied with an additional signal which is based on the signal of a second exhaust gas analyzer probe arranged downstream from the second catalytic portion.

### BRIEF DESCRIPTION OF THE FIGURE

The Figure shows an exemplary embodiment and/or exemplary method of the present invention.

### DETAILED DESCRIPTION

The exemplary method concerns regulating the fuel/air ratio of an internal combustion engine having a first cylinder group whose exhaust gases are guided through a first exhaust duct area and whose fuel/air ratio is set by a regulating circuit on the basis of the signal of a first exhaust gas analyzer probe arranged upstream from a first catalytic portion of the first exhaust duct area, and having a second cylinder group whose exhaust gases are guided through a second exhaust duct area having a second catalytic portion, and the fuel/air ratio of this second cylinder group is influenced by a variable from the first regulating circuit.

In addition, the system relates to an electronic control unit implementing an exemplary method and/or an exemplary device having such an electronic unit including a first and a second exhaust gas analyzer probe. The exemplary device may output manipulated variables for regulating the fuel/air ratio of an internal combustion engine having a first cylinder group whose exhaust gases are guided through a first exhaust duct area, and whose fuel/air ratio is set by a regulating circuit on the basis of the signal of the first exhaust gas analyzer probe arranged upstream from a first catalytic portion of the first exhaust duct area, and having a second cylinder group whose exhaust gases are guided through a second exhaust duct area having a second catalytic portion, and whose fuel/air ratio is influenced by a variable from the first regulating circuit.

With an electronic control unit, the one variable from the first regulating circuit may be the signal of the first exhaust gas analyzer probe, and the electronic control unit may set the fuel/air ratio of the second cylinder group on the basis of this signal via a second regulating circuit. The second regulating circuit may be supplied with an additional signal based on the signal of a second exhaust gas analyzer probe which may be arranged downstream from the second catalytic portion.

In addition, an exemplary device may be used in that the one variable from the first regulating circuit may be the signal of the first exhaust gas analyzer probe, and in that the exemplary device may include a second exhaust gas analyzer probe arranged downstream from the second catalytic portion.

The manipulated variable for the fuel/air ratio of the second cylinder group may be set on the basis of the signal of the first exhaust gas analyzer probe via a second regulating circuit, and the second regulating circuit may be supplied with an additional signal based on the signal of the second exhaust gas analyzer probe.

The elimination of a front exhaust gas analyzer probe may be desirable. The elimination of one of the front exhaust gas analyzer probes may result in a cost savings. An exhaust gas analyzer probe, the cable, and the associated signal conditioning circuit within the control unit may be eliminated. The elimination of one of the front probes may be accomplished by using the signal of a front probe not only for regulating one cylinder group, but also for regulating both cylinder groups. The front probe of one cylinder group thus may serve simultaneously as a virtual probe for the other cylinder group.

The exemplary method according to the present invention may provide an additional measure in that the signal of a third exhaust gas analyzer probe, arranged downstream from the first catalytic portion, may be processed via a third regulating circuit to yield a manipulated variable which influences the formation of a manipulated variable in the first regulating circuit.

An exemplary refinement may provide that the signal based on the signal of the second exhaust gas analyzer probe is the manipulated variable of a fourth regulating circuit.

With regard to the exemplary device, an exemplary refinement may provide that the first exhaust gas analyzer probe is a broad-band probe.

An additional measure may provide that the second and third exhaust gas analyzer probes are each a Nernst probe.

An exemplary embodiment of a Nernst probe is described on page 491 (491) of the Kraftfahrttechnisches Taschenbuch, 22^{nd} Edition, VDI Publishers Düsseldorf, ISBN 3-18-419122-2 (Automotive Handbook 4^{th} Edition, SAE Society of Automotive Engineers, USA, ISBN 1-56091-918-3). A broad-band probe as an exemplary embodiment of the first exhaust gas analyzer probe is also described in the same book on the following page 492 (492). The broad-band probe has a measuring gap which is connected to the exhaust gas via a gas intake orifice.

Furthermore, the measuring gap has an electrochemical pump cell with which oxygen may be pumped from or into the measuring gap. An electronic circuit may regulate the voltage applied to the pump cell so that the composition of the gas inside the measuring gap is constant at lambda=1. The pump current Ipbc required here delivers a measure for the oxygen content of the exhaust gas. In other words: the broad-band probe delivers a current signal I Probe-Before-Cat. In contrast, the Nernst probe delivers a voltage signal U Probe-After-Cat.

The Figure shows an internal combustion engine 10 having a first cylinder group 12 and a second cylinder group 14. The cylinders are supplied with air or with a fuel/air mixture from an intake system 16. The intake system has a power actuator 18, such as, for example, a throttle valve. The air volume flowing to the internal combustion engine via the throttle valve is measured by an air flow sensor 20. The injection period is calculated in block 22 on the basis of the air volume measured. The injection pulse durations output by block 22 are base values for controlling a first fuel metering device 24 and a second fuel metering device 26. First fuel metering device 24 is assigned to first cylinder group 12, and second fuel metering device 26 is assigned to cylinder group 14.

Fuel metering devices 24, 26 may be implemented in the form of cylinder-specific fuel injectors, for example. In the illustrated configuration fuel metering devices 24 and 26 meter the fuel into cylinder group-specific portions 28 and 30 of intake system 16. Reference number 28 represents the portion assigned to first cylinder group 12 and reference number 30 represents the portion assigned to second cylinder group 14. This illustration corresponds to an intake-manifold injection. The engine aspirates a fuel/air mixture in this case.

The devices (and/or methods) are not limited to intake-manifold injection, but it may also be usable in a similar form in a gasoline direct injection where the fuel is metered directly into the combustion chambers of the engine. The exhaust gases of cylinder group 12 are supplied into a first exhaust duct area 32 which has a first catalytic portion 34. First exhaust duct area 32 also has a first exhaust gas analyzer probe 36 which is arranged upstream from first catalytic portion 34.

In addition, there is a third exhaust gas analyzer probe 38 arranged downstream from first catalytic portion 34. The signal of first exhaust gas analyzer probe 36 is processed in a first controller 40 to yield a manipulated variable which, via a first gate 42, corrects the injection period output by block 22.

First fuel metering device 24 together with first cylinder group 12, first exhaust gas analyzer probe 36, first controller 40, and first gate 42 forms a first regulating circuit for regulating the fuel/air ratio of first cylinder group 12. A control intervention based on the signal of third exhaust gas analyzer probe 38 is superimposed on this first regulating circuit. The signal of third exhaust gas analyzer probe 38 is supplied to a differential gate 44 and is compared there with a setpoint value from a first setpoint value generating arrangement 46. The difference of the two values is supplied as a system deviation of the third regulating circuit to a third controller 48, which forms a manipulated variable for influencing first controller 40. This manipulated variable may correct the setpoint value of the first regulating circuit for example.

Alternatively or complementary to a correction of the setpoint value, an asymmetrical correction of other control parameters may also be provided, e.g., the P- and/or I components of a PI controller, or a correction of delay periods with which a probe signal change influences the manipulated variable. The series circuit described of a first and a third regulating circuit has the function mentioned above, namely to enable a quick mixture regulation using the first regulating circuit and to perform a slower but more precise correction using the third regulating circuit.

According to an exemplary embodiment and/or exemplary method of the present invention, the signal of first exhaust gas analyzer probe 36 is used not only as an input variable for first controller 40 for regulating the fuel/air ratio of first cylinder group 12 of internal combustion engine 10, but also for regulating the fuel/air ratio of second cylinder group 14.

To achieve this, the signal of first exhaust gas analyzer probe 36 is supplied to a second controller 50. The manipulated variable formed by second controller 50 influences the injection signal formation for second fuel metering device 26 via a second gate 52 and thus the fuel/air ratio of second cylinder group 14 of internal combustion engine 10.

First exhaust gas analyzer probe 36, arranged in first exhaust duct area 32 separated from the second exhaust duct area of second cylinder group 12, may thus be used as a virtual probe for a second regulating circuit which is composed of fuel metering device 26, second cylinder group 14, first exhaust gas analyzer probe 36, second controller 50, and second gate 52.

A fourth regulating circuit, composed of a second exhaust gas analyzer probe 56 downstream from a second catalytic portion 58, a second differential gate 60, a second setpoint generating arrangement 62, and a fourth controller 64, is connected in series to the second regulating circuit. The fourth regulating circuit may correct the differences in the mixture formation of the two cylinder groups. Such differences may result, for example, from different tolerances of the fuel injectors of the two cylinder groups 12, 14.

First controller 40 corrects the tolerances of the fuel injectors of first cylinder group 12. However, this correction may not necessarily have to be accurate for the injection periods of second cylinder group 14, so that an additional correction via the fourth regulating circuit downstream from the second regulating circuit may be required. The downstream regulation of second cylinder group 14 corrects the drifts of first exhaust gas analyzer probe 36 and the cylinder group-specific mixture differences which result, e.g., from different fuel injectors or from steady-state charge differences.

What is claimed is:

1. A method of regulating a fuel/air ratio of an internal combustion engine, in which exhaust gases of a first cylinder group are guided through a first exhaust duct area and in which exhaust gases of a second cylinder group are guided through a second exhaust duct area having a second catalytic portion, the method comprising:
setting a fuel/air ratio of the first cylinder group via a first regulating circuit based on a first signal of a first exhaust gas analyzer probe arranged upstream from a first catalytic portion of the first exhaust duct area;
influencing a fuel/air ratio of the second cylinder group by a variable from the first regulating circuit, the variable being the first signal;
setting the fuel/air ratio of the second cylinder group based on the first signal via a second regulating circuit; and
supplying an additional signal to the second regulating circuit based on a second signal of a second exhaust gas analyzer probe arranged downstream from the second catalytic portion.

2. The method of claim 1, further comprising:
processing a third signal of a third exhaust gas analyzer probe arranged downstream from the first catalytic portion via a third regulating circuit to yield a manipulated variable which influences a formation of a manipulated variable in the first regulating circuit.

3. The method of claim 1, wherein the additional signal is a manipulated variable of a fourth regulating circuit.

4. An electronic control unit for regulating a fuel/air ratio of an internal combustion engine having a first cylinder group, a second cylinder group, a first exhaust duct area to guide exhaust gases of the first cylinder group and having a first catalytic portion, and a second exhaust duct area to guide exhaust gases of the second cylinder group and having a second catalytic portion, the electronic control unit comprising:
a first regulating circuit to set a fuel/air ratio of the first cylinder group based on a first signal that is received from a first exhaust gas analyzer probe arranged downstream from the first catalytic portion to generate the first signal, and to generate a variable for influencing a fuel/air ratio of the second cylinder group, the variable being the first signal; and
a second regulating circuit to set the fuel/air ratio of the second cylinder group based on the first signal and a second signal that is received from a second exhaust gas analyzer probe arranged downstream from the second catalytic portion to generate the second signal.

5. A system for outputting manipulated variables for regulating a fuel/air ratio of an internal combustion engine having a first cylinder group, a second cylinder group, a first exhaust duct area to guide exhaust gases of the first cylinder group and having a first catalytic portion, and a second exhaust duct area to guide exhaust gases of the second cylinder group and having a second catalytic portion, the system comprising:
an electronic control unit;
a first exhaust gas analyzer probe arrangeable upstream from the first catalytic portion to generate a first signal;
a second gas analyzer probe arrangeable downstream from a second catalytic portion to generate a second signal;
a third gas analyzer probe to generate a third signal;
a first regulating circuit to set a fuel/air ratio of the first cylinder group based on the first signal, and to generate a variable for influencing a fuel/air ratio of the second cylinder group; and
a second regulating circuit to set the fuel/air ratio of the second cylinder group based on the first signal and the second signal.

6. The device of claim 5, wherein the first exhaust gas analyzer probe is a broad-band probe.

7. The device of claim 5, wherein the second and the third exhaust gas analyzer probes are each a Nernst probe.
